(19) United States
(12) Patent Application Publication
(10) Pub. No.: US 2015/0058048 A1
(43) Pub. Date: Feb. 26, 2015

(54) SYSTEM AND METHOD FOR IDENTIFYING PASSENGERS AND CHAUFFEURS

(71) Applicant: SHMUEL EPSHTEIN, MODI'IN (IL)

(72) Inventor: SHMUEL EPSHTEIN, MODI'IN (IL)

(21) Appl. No.: 13/970,645

(22) Filed: Aug. 20, 2013

(51) Int. Cl. G06Q 10/02

(52) U.S. Cl. CPC G06Q 10/02
USPC 705/5

(57) ABSTRACT

A method and system for identification of a passenger by a personal chauffeur in a transportation center, the system including a server configured to receive input passenger data and generate a serial number assigned thereto, the server also configured to receive chauffeur contact information, an electronic display coupled to the server for displaying generated serial numbers, a plurality of visual identification objects, a dispensing device, coupled to the server, for dispensing one of the visual identification objects in response to input of the serial number by a passenger, and communication elements in the server for communicating information relating to a dispensed visual identification object to the personal chauffeur using the chauffeur contact information.

### FIELD OF THE INVENTION

The present invention relates to methods of identification, in general and, in particular, to a method and system for mutual identification of passengers and the chauffeurs who await them in transportation centers.

### BACKGROUND OF THE INVENTION

Often, when traveling in unfamiliar countries or when arriving at a new city in need of a drive to a hotel or other destination, a traveler will arrange for a driver or personal chauffeur to meet her or him at the transportation center, i.e., train station, airport, port, etc. At present, these chauffeurs must stand and wait near an entrance to the center of the station, typically holding a sign with the traveler's or guest's name written thereon. Holding up such signs often is accompanied by feelings of discomfort, awkwardness and lack of aesthetic presentation. The passenger may arrive tired and must scan the entire hall in order to find a sign with his name, and is often faced with inaccuracies and differences between the name that appears on the sign and the actual name of the traveler, or must try to understand printing or handwriting that is not clear or is uneven. Many times, there is no place to place such a sign and the chauffeur must stand for a long time holding the sign in his hands. In addition, the chauffeur must estimate when the passenger should arrive and wait until the passenger emerges, in order to avoid missing her or him completely.

Accordingly, there is a long felt need for a method and system that would provide an easier and more efficient recognition between the passenger and the chauffeur, and it would be very desirable if such a method permitted the chauffeur to move about the terminal until notified that the passenger has arrived.

### SUMMARY OF THE INVENTION

The present invention relates to a system and method for simple and accurate reciprocal identification of passengers and their drivers or personal chauffeurs in airport terminals and other transportation centers, without requiring the chauffeurs to hold a sign and wait in one location for a long period of time for the passenger to emerge.

There is provided, according to the present invention, a method for reciprocal identification of a passenger and a personal chauffeur, the method including receiving in a computer terminal a name of a passenger and at least a phone number of a chauffeur; assigning a serial number to the passenger; displaying the assigned serial number on an electronic display; receiving from the passenger an input of the serial number; providing to the passenger a identification object with the serial number; and sending a description of the identification object, and possibly the serial number or a photograph, to the chauffeur for identification of the passenger.

According to some embodiments, the step of providing includes printing out a color coded sheet with the serial number; and the step of sending includes sending the color coded sheet to the chauffeur.

According to further embodiments, the method further includes receiving a photograph of the chauffeur; and the step of providing includes providing the photograph on the identification object.

According to further embodiments, the method further includes receiving a photograph of the passenger; and the step of sending includes sending the photograph of the passenger to the chauffeur.

There is also provided, according to the present invention, a system for reciprocal identification of a passenger and a personal chauffeur, the system including a computer coupled to an electronic display, a first terminal having a user input interface and a second terminal having a user input interface, the first and second terminals being coupled to said computer and disposed in a transportation center, a dispenser of identification objects coupled to the computer, and communication elements in the server for communicating information relating to a dispensed visual identification object to the personal chauffeur using the chauffeur contact information.

According to some embodiments, the first and second terminals are a single terminal.

### BRIEF DESCRIPTION OF THE DRAWINGS

The present invention will be further understood and appreciated from the following detailed description taken in conjunction with the drawings in which:

FIG. 1 is a schematic illustration of a system for reciprocal identification constructed and operative in accordance with one embodiment of the present invention; and

FIG. 2 is a flow chart illustrating a method for mutual identification, according to one embodiment of the invention.

### DETAILED DESCRIPTION OF THE INVENTION

The present invention relates to a system and method for simple and accurate reciprocal identification of passengers and the chauffeurs who await them in airport terminals and other transportation centers, which eliminates the need for a hand-held sign. This is accomplished by providing a server, computer terminals for the chauffeurs and passengers coupled to the server, an electronic display, also coupled to the server, for displaying serial numbers assigned to different passengers, and a dispensing device for dispensing a identification object to each passenger. The server further includes communication capability for informing each chauffeur of the identification object dispensed to the passenger he is seeking.

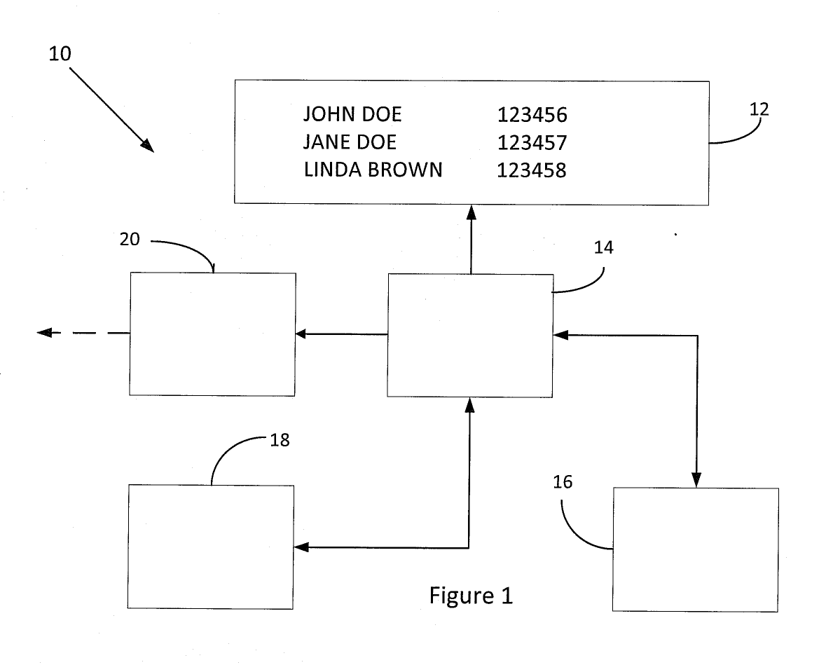

Referring now to FIG. 1, there is shown a schematic illustration of a system 10 for reciprocal identification of a chauffeur and passenger in a transportation center, constructed and operative in accordance with one embodiment of the present invention. System 10 includes a server 14. Server 14 may be any appropriate computing device including a processor, non-volatile memory storage capability and communication capability. An electronic display 12 hung in an arrivals hall or near an entrance to a transportation terminal, capable of displaying numbers and texts in various languages, is coupled to a server 14, for viewing by the passenger. Server 14 is coupled to a first, chauffeur computer terminal 16, preferably disposed near the exit end of the arrival hall. Chauffeur computer terminal 16 may have any conventional user interface (e.g., keypad, USB socket, memory slot) for input of passenger details and chauffeur contact information by the chauffeur, as described in detail below. The chauffeur contact information may include, for example, a cellular phone number or e-mail address. Electronic display 12 is configured to display the passenger name input to chauffeur terminal 16 and a serial number assigned to that passenger by server 14 for viewing by passengers arriving at the terminal. While it may be viewable by the chauffeur, it is not necessary that the chauffeur have access to view the display 12. In some embodiments, the electronic display 12 can be the display of the passenger's mobile device, and the serial number can be forwarded directly to the passenger.

Server 14 is also coupled to a second, passenger computer terminal 18, preferably disposed near the passenger end of the arrival hall, or near an entrance to the transportation terminal. Passenger computer terminal 18 may have any conventional user interface for input of the passenger's serial number, by the passenger, as described in detail below.

The system can include a single server with a first terminal near the chauffeur's end of the terminal or arrival hall, and a second terminal at the passenger's end of the terminal or arrival hall, as described above. It will be appreciated that some transportation centers have a central arrival hall or exit area separate from the passenger's entrance area to the terminal. In this case, the passenger terminal and the electronic display may be disposed in the passenger's entrance area, while the chauffeur terminal could be disposed near the exit area. Alternatively, a single terminal for use by both the passenger and the chauffeur can be disposed in a central location or near the exit from the arrivals hall, if there is a separate arrival hall. According to another embodiment, the passenger's and/or the chauffeur's electronic tablet or smart cellular phone can serve as the passenger and/or chauffeur terminal, respectively. In this case, the tablet or smart phone would contact the server directly, as by WiFi®, or in any other fashion, to input the required information. The server includes appropriate communication elements to permit communication via instant messaging, e-mail, short message service, WiFi®, Bluetooth®, etc.

The display of the system can be located in the arrivals hall where it is visible to both passenger and chauffeur or it can be located near the passengers' entrance to the arrivals hall or to the transportation terminal. The latter permits earlier notification to the chauffeur of the arrival of the passenger. It will be appreciated that the electronic display can be a hand-held display, such as the display of the passenger's electronic tablet or smart phone. In this case, the server would be provided with contact details of the passenger, and would send the appropriate serial number to the passenger, such as via instant messaging, e-mail, short message service, Bluetooth®, etc., for display on his hand-held display.

At least one dispensing device 20, for dispensing visual identification objects, is also coupled to server 14 and disposed adjacent to or integrally formed with passenger terminal 18. Dispensing device 20 may be a separate device for dispensing 2- or 3-dimensional objects, displaying a visually identifiable pattern, or may be a color printer, coupled to server 14, for printing colored cards or sheets, etc., each having a color code, shape, logo, alphanumeric symbol, or other means of identification thereon. Preferably, the visual identification objects are different from one another during a selected period of time, e.g., several hours, to prevent confusion. If desired, the dispensed object may also include the serial number of the passenger, for verification of identity. The identification object can be, for example, a card or sheet, a luggage tag, or a two- or three-dimensional promotional gadget, advertising the name of the chauffeur service, etc., for easy recognition of the passenger by the chauffeur. If desired, a picture of the chauffeur may be input to server 14 together with the passenger's details, and this picture is also provided on the identification object or printed on the card or sheet, so as to enable the passenger to recognize the chauffeur.

Preferably, the identification object is configured such that it can be temporarily affixed to a luggage cart or to the passenger's suitcase, as by a steward from the plane or by the passenger him- or herself. Alternatively, a hanger or tie element can be provided on the identification object. In this way, the passenger need not hold the object in his hand while awaiting the chauffeur, but can hang the object on a hand-carried bag, on the passenger's clothes, suitcase or luggage cart, and then can load his or her luggage and proceed towards the exit of the terminal, until found by the chauffeur.

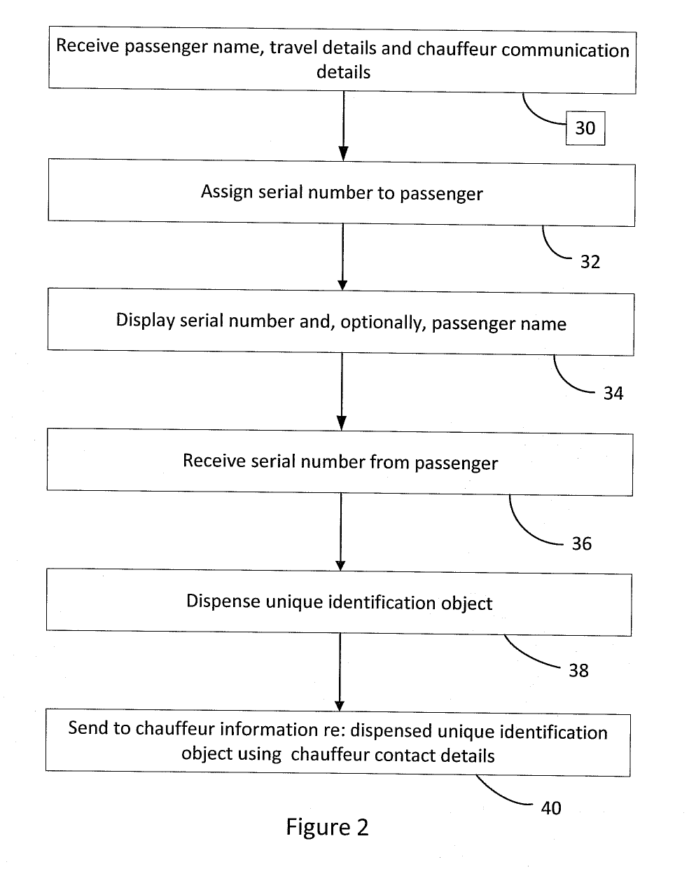

The method of reciprocal identification, according to exemplary embodiments of the present invention, is as follows, with reference to FIG. 2. When a passenger makes arrangements to be met at a transportation center (i.e., airport, train or subway station, boat terminal, etc.), his or her name and travel details are given to the chauffeur who is to meet him or her. The chauffeur inputs these details to the server via the chauffeur terminal, together with his own contact information (block 30). Typically, the chauffeur will key into the computer the name of the passenger he is waiting for and the number of the passenger's flight/train or other identification data, such as name of hotel, etc. This can be accomplished manually when the chauffeur arrives at an entrance to the transportation center, via the Internet or by means of an application running on a cellular smart phone of the chauffeur. Where the passenger has made reservations in advance, the details can even be provided to the server in advance, as by the chauffeur's office, and stored therein until the date of arrival.

The server now assigns a serial number to that passenger for use in mutual identification by the chauffeur (block 32). The name of the passenger and the serial number are sent by the server to the display and are displayed on the electronic display (block 34). The chauffeur is now free until he or she receives a notification that the passenger has arrived or emerged.

When a passenger, or his accompanying person, who knows in advance that the chauffeur will be picking him up, arrives in the terminal of the airport, train, boat, bus or other transportation system, he will see the name of the passenger displayed on the electronic display in the terminal hall and/or on his hand-held display. Next to his name, he will see the serial number that was assigned to him. The passenger must note this number and enter it into the passenger computer terminal in the passenger's end of the arrivals hall or terminal entrance (block 36).

As soon as the passenger inputs the serial number into the passenger computer terminal, the server instructs the dispensing device to dispense to the passenger a visual identification object (block 38), as described above. At the same time, a message is sent (block 40) to the telephone of the personal chauffeur, using said chauffeur contact information, including information relating to a dispensed visual identification object. This information can be a textual description, a picture, the serial number, or any other information that can be used to visually identify the object. For example, the chauffeur can receive a picture and/or other description of the identification object given to the passenger who has arrived, such as the color of the card or sheet that the passenger was given, and possibly the serial number of the passenger. This message may be sent using the contact information input by the chauffeur, such as by Short Message Service (SMS) or e-mail, or in any other suitable fashion. The chauffeur uses this description to locate the correct passenger, and may optionally verify the passenger's identity by means of the serial number. In this way, the chauffeur and passenger can easily and rapidly identify one another, in a clean and aesthetic fashion, even in a very large transportation hub. If desired, the passenger computer terminal can use an image capturing device, such as a camera, to take a picture of the passenger after he or she inputs the serial number. This picture may be sent, together with the message, to the chauffeur, so as to enable the chauffeur to recognize the passenger. In some embodiments, the passenger will then receive a picture of the chauffer (which was previously input to the server) to his mobile device and/or output by the dispensing device).

If desired, a second dispensing device may be provided, coupled to the server, for dispensing to the chauffeur an identification object identical to that dispensed to the passenger, for ease of identification and confirmation.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A system for identification of a passenger by a personal chauffeur in a transportation center, the system comprising:
a server configured to receive input passenger data and generate a serial number assigned thereto;
said server also configured to receive chauffeur contact information;
an electronic display coupled to said server for displaying generated serial numbers;
a plurality of visual identification objects;
a dispensing device, coupled to the server, for dispensing one of said visual identification objects in response to input of said serial number by a passenger; and
communication means in the server for communicating information relating to a dispensed visual identification object to the personal chauffeur using said chauffeur contact information.

2. The system according to claim 1, further comprising a passenger computer terminal and a chauffeur computer terminal coupled to said server.

3. The system according to claim 2, wherein the passenger and chauffeur computer terminals are a single computer terminal.

4. The system according to claim 1, wherein the dispensing device includes a color printer coupled to the server.

5. The system according to claim 1, wherein the dispensing device includes a color printer coupled to said passenger computer terminal.

6. The system according to claim 1, wherein the dispensing device is a device for dispensing 2-dimensional or 3-dimensional promotional objects.

7. A system for identification of a passenger by a personal chauffeur in a transportation center, the system comprising:
a server;
a chauffeur computer terminal coupled to said server for inputting passenger details and chauffeur contact details;
an electronic display coupled to said server for displaying passenger data and a serial number assigned to the passenger by said server;
a plurality of visual identification objects;
a dispensing device, coupled to the server, for dispensing said visual identification objects and disposed near the passenger computer terminal;
a passenger computer terminal coupled to said server for inputting passenger details and causing the dispensing device to dispense one of said visual identification objects; and
communication means in the server for communicating a description of a dispensed visual identification object to the personal chauffeur using said chauffeur contact details.

8. The system according to claim 7, wherein the dispensing device includes a color printer coupled to said passenger computer terminal.

9. The system according to claim 7, wherein the dispensing device is a device for dispensing 2-dimensional or 3-dimensional promotional objects.

10. The system according to claim 7, further comprising a second dispensing device coupled to the server for dispensing a copy of the object associated with the passenger to the chauffeur.

11. A method for identification of a passenger and a personal chauffeur, the method comprising:
receiving a name of a passenger and at least contact details of a chauffeur;
assigning a serial number to said passenger;
displaying the assigned serial number on a display;
receiving from the passenger an input of the serial number;
dispensing to the passenger a visual identification object associated with said input serial number; and
communicating information relating to said dispensed identification object to said chauffeur for identification of the passenger.

12. The method according to claim 11, wherein said step of displaying includes displaying said passenger name with said assigned serial number.

13. The method according to claim 11, wherein:
said step of providing includes printing out a color coded sheet with said serial number; and
said step of communicating includes sending a description of said color coded sheet to the chauffeur.

14. The method according to claim 11,
further comprising receiving a photograph of the chauffeur;
and wherein the step of providing includes providing said photograph on the identification object.

15. The method according to claim 13,
further comprising receiving a photograph of the chauffeur;
and wherein the step of printing includes also printing said photograph on the color coded sheet.

16. The method according to claim 11,
further comprising receiving a photograph of the passenger;
and wherein the step of communicating includes also communicating the photograph of the passenger to the chauffer.

17. The method according to claim 11, wherein the step of dispensing includes dispensing 2-dimensional or 3-dimensional promotional objects.
